(19) United States
(12) Patent Application Publication
(10) Pub. No.: US 2023/0334473 A1
(43) Pub. Date: Oct. 19, 2023

(54) Systems and Methods for Blockchain-Based Software Key Distribution

(71) Applicant: VAULTN BV, Amsterdam (NL)

(72) Inventors: Emrah KARA, Amsterdam (NL); Berkan OZGUR, Karabaglar (TR)

(73) Assignee: VAULTN BV, Amsterdam (NL)

(21) Appl. No.: 18/171,316

(22) Filed: Feb. 17, 2023

Related U.S. Application Data
(60) Provisional application No. 63/268,197, filed on Feb. 17, 2022.

(51) Int. Cl. G06Q 20/36; H04L 9/14; H04L 9/00; G06Q 20/38

(52) U.S. Cl. CPC G06Q 20/3672; H04L 9/14; H04L 9/50; G06Q 20/389; G06Q 20/3825

(57) ABSTRACT

A blockchain-based approach to the distribution of software keys to one or more end users including a computer implemented system for distributing tokens corresponding to one or more keys comprising a network connected system using a vault device with one or more blockchains to determine a hash value of and encrypt the one of more keys; tokenize one or more of the keys; mint one or more coins with batched token addresses in a distributed leger; extract one or more of the keys from token batches on request, and then decrypt and distribute the one or more extracted keys to one or more end users.

### CROSS-REFERENCES TO RELATED PATENT APPLICATIONS

This application claims benefit under U.S. Provisional Patent Application No. 63/268,197 filed on Feb. 17, 2022, which is hereby specifically incorporated by reference in its entirety into the present disclosure.

### STATEMENT REGARDING FEDERALLY SPONSORED RESEARCH OR DEVELOPMENT

Not Applicable.

### REFERENCE TO SEQUENCE LISTING, A TABLE, OR A COMPUTER PROGRAM LISTING COMPACT DISK APPENDIX

Not Applicable.

### BACKGROUND

The field of the inventive subject matter generally relates to software key distribution systems and more particularly it relates to systems and methods for blockchain-based software key distribution.

For software publishers, the loss of copyright protection due to piracy has been a long-standing issue. To prevent unauthorized copying and unlawful distribution of software goods, publishers have used Digital Rights Management and copy-protection approaches such as printed key codes or online license key validations. Furthermore, authorization of software through the utilization of license keys is the driving force of the software market due to its cost-effectiveness, convenience, and accessibility means.

Software product keys usually consist of a series of numbers and letters. This key is passed manually or automatically to a verification method that is provided by the software or on a public server, which controls the validity of the key. However, even if it's proven effective, license validation method defenses are penetrable via redirection of domain names to fake authentication servers and/or key generators that imitate the software vendor's own authentication system, reverse engineering, and removal of software license verification methods, distribution of pre-authenticated software, and the like. In addition to the weak points of the validation methods, delivery of the pre-created keys between publishers, distributors, and retailers is also vulnerable as thousands of keys can be intercepted and cause damage sometimes with the possibility of an unauthorized release of large numbers of private key numbers. For example, license keys are usually distributed via email as text files, (e.g. in .csv format) which makes keys vulnerable to being misplaced, copied or stolen.

The mysterious “Satoshi Nakamoto” created a technological mechanism for the means of reconstructing the economic ecosystem fed by the desire to form a financial system that is independent of the conventional fiat currency system, decentralized cryptocurrency that is distributed on a blockchain. Through a decade journey of technological breakthroughs, propelled by the invention of smart contracts and the popularity of cryptocurrencies as an exchange value, many entities in the field of finance, software, health, education, etc. are migrating to or experimenting with blockchain-based systems aiming for fast, transparent, reliable, secure operations.

To clarify further term usage, some descriptions of blockchain-related terms such as coins, tokens, blockchain, and their examples are provided herein.

Coins are cryptocurrencies that have a standalone, independent blockchain, such as Bitcoin, Ethereum, NEO, etc. Tokens are currencies of a special type of smart contract that allows users to create, issue, and manage tokens that are derivatives of the main blockchain. For example, developers may choose how many units they want to issue and where these new tokens will be transferred when they are created when they create their token. At this stage, they may pay some of the native coins on the blockchain on which the token is being created. Most tokens exist to be used as utility tokens with decentralized applications, for example, EOS blockchain tokens can allow an individual to vote for block creators. There are two main types of tokens that can be encountered in the cryptocurrency scene, fungible and non-fungible tokens (NFTs). As its definition suggests, fungible good is standardized, and the units of fungible goods don't have any uniqueness. However, NFTs are units of data stored in a blockchain and are not interchangeable with other assets. The term “Fungible” is derived from the literature on economy and accounting and is defined as anything interchangeable with identical or similar objects such as traditional forms of currency. This new form of the token was introduced with the ERC-721 standard in late 2017. ERC-721 deviates significantly from the ERC-20 standard as it extends the common interface for tokens by additional functions to ensure that tokens based on it are distinctly non-fungible and thus unique. The primary interest in NFTs emerges from uses that involve creating scarcity to ascribe value to code-built digital objects. An NFT can, for example, imprint a blockchain with a unique signature for the ownership of a digital asset. For creative works, including images and other objects that one would “autograph” in the physical world, there is an evident use for ascribing unique ownership on metadata through a cryptographic hash function. Considering the aforementioned background information there is room for improvement in the software license distribution mechanisms.

As used with many of the embodiments, cryptocurrency coins are a type of digital currency that are managed on a specific blockchain, while tokens are digital assets that are created and managed on top of an existing blockchain platform. Encrypted keys can be used to secure access to cryptocurrency wallets and accounts and are essential for authorizing transactions on the blockchain.

Cryptocurrency coins, tokens, and encrypted keys are all related concepts within the broader field of cryptocurrency and blockchain technology. Cryptocurrency coins are digital currencies that are typically created and managed on a specific blockchain. Examples of cryptocurrency coins include Bitcoin, Litecoin, and Ethereum. Each coin is represented by a unique identifier on the blockchain and is associated with a specific value. Coins are typically used as a medium of exchange or a store of value, much like traditional currencies. A “SKU coin” is an exemplary coin used with several embodiments of the claimed subject mater.

Tokens are digital assets that can be created and managed on top of an existing blockchain platform, such as Ethereum or Binance Smart Chain. Tokens can represent any kind of asset or utility, and are often used for fundraising, trading, and as rewards in decentralized applications. Tokens can be bought, sold, and traded just like cryptocurrency coins.

Encrypted keys are strings of characters that can be used to access and control a particular wallet or account on a blockchain. This key is typically generated by a wallet application and is stored securely on the user's device. Encrypted keys can be essential for authorizing transactions and maintaining the security of a cryptocurrency wallet or account.

Cryptocurrency coins typically contain a number of metadata fields, depending on the specific blockchain and the type of coin. Here are a few examples of metadata that may be contained within cryptocurrency coins:
Transaction details: Most cryptocurrency coins contain information about the transactions they have been involved in. This can include details such as the sender and recipient addresses, the amount of the transaction, the date and time of the transaction, and any associated fees.
Smart contract information: Some cryptocurrency coins, such as Ethereum, are designed to support smart contracts. These contracts are self-executing agreements with the terms of the agreement between buyer and seller being directly written into lines of code. The smart contract code is stored on the blockchain and can be viewed by anyone with access to the blockchain.
Block and mining information: Cryptocurrency coins are created through a process called mining, which involves solving complex mathematical problems. The blockchain records details about each block that is added to the chain, including the miner who solved the block and the time at which it was added to the chain.
Token metadata: Many cryptocurrencies are built on top of existing blockchain platforms, such as Ethereum or Binance Smart Chain, and are referred to as “tokens”. These tokens may contain additional metadata fields that are specific to the token, such as the total supply of the token, the token symbol, and the decimals used to represent the token's value.
Identity information: Some cryptocurrencies, such as Ripple, are designed to support identity verification and authentication. These coins may contain metadata fields that relate to a user's identity, such as their name, email address, and other contact details.

An array of token addresses typically contains a list of unique identifiers that represent individual tokens on a specific blockchain. The specific information that can be included in this array will depend on the particular blockchain and token standard being used.

For example, if the array of token addresses is related to the Ethereum blockchain, it might include the addresses of tokens that comply with the ERC-20 standard. In this case, the array could include the following information for each token address:
Token name: The name of the token being represented by the address.
Token symbol: The symbol or ticker code that represents the token.
Decimals: The number of decimal places that the token uses to represent its value.
Total supply: The total number of tokens that have been created for this particular token address.
Contract address: The address of the smart contract that governs the token's behavior and functionality.

If the array of token addresses is related to a different blockchain or token standard, the information included may be different. For example, the array could include information about token ownership, the amount of the token held by each address, and the date of the most recent token transaction. Ultimately, the information that is included in the array of token addresses will depend on the specific use case and the requirements of the system or application that is using it.

Many of the embodiments use a private key. For example, if an end user has extracted a private key from a cryptocurrency wallet or account, they will have the ability to access and control the assets associated with that key. Depending on the specific blockchain and wallet software being used, there are a number of things an end user can do with an extracted key:
Send or receive cryptocurrency: With access to a private key, an end user can send or receive cryptocurrency on the blockchain. They can use the key to sign and broadcast transactions that move funds between addresses;
Access decentralized applications (dapps): Many blockchain platforms have decentralized applications (dapps) that run on top of the blockchain. With a private key, an end user can access these dapps and interact with them, which could include making transactions or using the dapp's functionality;
Manage token assets: If the private key is associated with a wallet that contains tokens, the end user can manage those tokens. This could include transferring tokens to other addresses, buying or selling tokens on a decentralized exchange, or using tokens within a dapp; and
Participate in staking or governance: Some blockchains allow token holders to participate in staking or governance processes, which involve locking up tokens to support the network or voting on changes to the blockchain.

As used in many of the embodiments, a smart contract template is a pre-designed code structure that defines the basic functionality and rules of a smart contract. A smart contract template typically contains a set of pre-defined variables, functions, and conditional statements that can be customized to suit a specific use case. The purpose of a smart contract template is to provide a standardized starting point for developers who want to create a smart contract without having to start from scratch.

As used in many of the embodiments, a public distributed ledger is a decentralized database that can be accessed and viewed by anyone on the internet. Public ledgers are generally maintained by a network of nodes that work together to validate transactions and maintain the integrity of the ledger. The most well-known example of a public distributed ledger is the Bitcoin blockchain.

As used in many of the embodiments, a private distributed ledger is a decentralized database that can only be accessed by a limited group of users. Private ledgers are typically owned and maintained by a single organization or a consortium of organizations. A private ledger is designed to provide enhanced privacy and control over the data, transactions, and access to the ledger. In a private ledger, typically only authorized parties have access to the ledger and are responsible for validating transactions.

One difference between public and private ledgers is the consensus mechanism used to validate transactions. Public ledgers typically use a consensus mechanism that is based on a proof-of-work (PoW) or proof-of-stake (PoS) algorithm, which requires a significant amount of computational power to validate transactions. In contrast, private ledgers can use alternative consensus mechanisms that are optimized for their specific use cases, such as a Byzantine Fault Tolerance (BFT) algorithm, which is designed to provide fast and secure transaction validation.

In many of the embodiments, private ledgers (as compared public ledgers) can be used for enhanced privacy and control over data, such as software licensing, as well as other industries such as supply chain management, healthcare, and financial services.

In many of the embodiments, a whitelist may be used. In the context of blockchain technology, a whitelist is a list of addresses or public keys that are allowed to participate in a particular blockchain network or a specific function within a blockchain application. The purpose of a blockchain whitelist is to restrict access to only authorized users or nodes and to prevent unauthorized access or misuse of the blockchain network.

A blockchain whitelist is typically used in permissioned blockchain networks where access to the network is restricted to a specific group of users or nodes. In such networks, each user or node is identified by a unique public key or address that is added to the whitelist. Only those users or nodes whose public keys or addresses are on the whitelist are allowed to participate in the network and perform certain functions, such as validating transactions, writing data to the blockchain, or accessing smart contracts.

For example, a supply chain management blockchain network may use a whitelist to restrict access to only authorized participants, such as manufacturers, suppliers, and distributors. A software licensing blockchain network may allow authorized participants to use or download software. Each participant's public key or address is added to the whitelist, allowing them to write data to the blockchain and track the movement of goods across the supply chain. The use of a blockchain whitelist can enhance the security and privacy of the blockchain network by preventing unauthorized access and ensuring that only authorized participants have access to the network.

In many of the embodiments, criteria are used for management of the whitelist. The criteria for a blockchain whitelist will depend on the specific use case and the requirements of the blockchain network. In general, the criteria for a whitelist are designed to ensure that only authorized users or nodes are allowed to participate in the network. Here are some examples of criteria that may be used to create a blockchain whitelist:
Identity verification: The blockchain network may require each user or node to undergo a thorough identity verification process before being added to the whitelist. This may include verifying personal information, such as name, address, and government ID, to ensure that the user is who they claim to be;
Authorization levels: The whitelist may be designed to include different authorization levels for different users or nodes based on their roles and responsibilities within the network. For example, some users may be authorized only to read data from the blockchain, while others may be authorized to write data and execute smart contracts;
Reputation: The blockchain network may use reputation scores or ratings to assess the trustworthiness of users or nodes before adding them to the whitelist. This may include factors such as previous participation in the network, adherence to network rules, and performance in executing transactions;
Membership criteria: The whitelist may include specific membership criteria, such as membership in a particular organization, geographical location, or industry. This can help to ensure that only relevant participants are added to the whitelist; and
Endorsements: The blockchain network may require endorsements or recommendations from existing users or nodes before adding new participants to the whitelist. This can help to ensure that new participants are trustworthy and have a good reputation within the network.

The criteria for a blockchain whitelist can be used to ensure that only authorized and trustworthy participants are allowed to participate in the network, while preventing unauthorized access and misuse of the network.

### SUMMARY

The illustrative embodiments provide computer implemented methods, apparatuses, and systems implementing computer usable program code to accelerate, reinforce security, and aid with transparency on the license key distribution process through all actors (creator, retailer, and the like.) More specifically systems and methods are used for blockchain-based software key distribution utilizing a multi-layer approach.

In several embodiments, a vault layer, a public blockchain, and a private subchain are used with key batches that are designated by the publisher to go through the vault layer and are encrypted, and then tokens equal to the number of keys in the batch are allocated in the private chain. For a given batch of tokens, a coin is minted in the public blockchain with the metadata that contains the array of token addresses for each token that is created. Further, coins represent N number of transferrable assets which is equal to the number of token addresses in the coin metadata. When X number of keys are to be sold, X number of tokens are transferred to the receiving wallet, coins are extracted and decrypted in the vault layer. When the process is completed, metadata of the coin in the public chain is updated as the extracted addresses are removed from the array, resulting in N-X number of token addresses and N-X number of tokens in the private sub-chain on the related batch.

In some of the embodiments, a computer implemented system for distributing tokens corresponding to one or more keys comprising a network connected system using a vault device with one or more blockchains wherein the network connected system determines a hash value of and encrypt the one of more keys; creates one or more tokens; mints one or more coins with batched token addresses in a distributed ledger; extracts one or more of the keys from the batched token addresses on request from a user, and decrypts and distributes the one or more extracted keys to one or more end users.

In some of these embodiments, the one or more extracted keys are software keys that may be used for online license activation by one or more recipients of the one or more extracted keys.

In some of these embodiments, the keys are batches of keys and the number of tokens created in the batch is equal to the encrypted keys that they represent, and an SKU coin is minted carrying token addresses associated with each token through its metadata in the one or more blockchains.

In some of these embodiments, if a request is made to extract a number of keys, an equal number of tokens and encrypted keys are extracted, decrypted and distributed.

In some of these embodiments, the one or more coins minted in a distributed ledger include metadata that contains the array of token addresses for each token that is created.

In some of these embodiments, the one or more coins represent N number of transferrable assets which is equal to the number of token addresses in the coin metadata wherein when X number of keys are to be sold, X number of tokens are transferred to the receiving wallet, coins are extracted and decrypted in the vault layer and wherein when the process is completed, metadata of the coin in the public chain is updated as the extracted addresses are removed from the array, resulting in N-X number of token addresses and N-X number of tokens in the private sub-chain on the related batch.

In some of these embodiments, the vault device encrypts the one or more keys using an encryption module and decrypts the one or more extracted keys using a decryption module.

In some of these embodiments, the one or more keys are assigned a hash for the identification of the one or more individual keys, and, for each key in the batch, a token is allocated in a private subchain and a smart contract template is created by a blockchain broker to mint on or more key batch coins in the distributed ledger.

In some of these embodiments, the extraction of keys by request of one or more end users is preapproved by a provider of the one or more keys so that only those one or more end users receive the one or more extracted keys.

In some of these embodiments, the one or more end users may preapprove, before or after receipt of the extracted keys, one or more third parties to receive one of more of the extracted keys, and in some of these embodiments the provider of the one or more keys may receive requests from third party users to be preapproved and grant or deny those requests so that the third parties can be accepted or denied inclusion of a listing on a whitelist of preapproved end users.

In some of these embodiments, the one or more keys extracted from the token batches may be sent to a retailer wallet so they can be decrypted and identified in the vault device wherein a key batch is returned to the retailer with one or more keys are distributed to one or more end users when the one or more end users complete one or more purchase transactions. In other embodiments, the one or more keys are distributed to one or more end users after an end user wallet has been whitelisted.

In many of the embodiments, the one or more end users transfer one or more batch tokens to one or more other receiving end users utilizing the vault device and a wallet application in communication with the distributed ledger. In some of these embodiments, the one or more end users transfer one or more batch tokens and the related one or more coins to one or more other receiving end users both on a public distributed ledger and a private distributed ledger. In other embodiments, once the one or more other receiving end users receive the one or more batch tokens and the related one or more coins, the one or more requesting end users requests the extraction of the batch tokens and the vault device parses the batch tokens and data store for paired hashes, identifies the paired keys, decrypts the paired keys, creates a key batch, and sends the resulting batch to the requesting end user.

Many of the embodiments also comprise a vault user interface including a computing device with a vault management application, a display, in communication with the network connected system wherein the vault management application received a request from a vault user interface user and, in response, transmits related data to the user device specific to the vault user interface user which can be displayed on the display. Some of these embodiments also include a vault interface including a computing device with a vault management application and a display, wherein the vault user interface is in communication with the network connected system and wherein the vault management application can receive a request from a vault interface user and, in response, transmit related data to the user device specific to the vault interface user and display the related data on the display.

In some of these embodiments, the vault interface allows the user to manage one or more products purchased using the one or more keys. In many of these embodiments, the vault interface can be used by the retailer to fetch related data to that specific vault user interface user so that the data can be used for key management related to the vault interface user.

Some of the described embodiments may refer to software keys that are used for online license activation. These described examples are shown for exemplary purposes as the embodiments may apply to other uses such as blockchain and NFT based implantations or many other uses. This, it should be recognized that the utility of the present systems and methods goes beyond the scope of the disclosed embodiments. For example, in the embodiments described in the detailed description, one can easily reproduce the embodiments for different software authorization methods utilizing keys or codes.

### DETAILED DESCRIPTION OF THE DRAWINGS

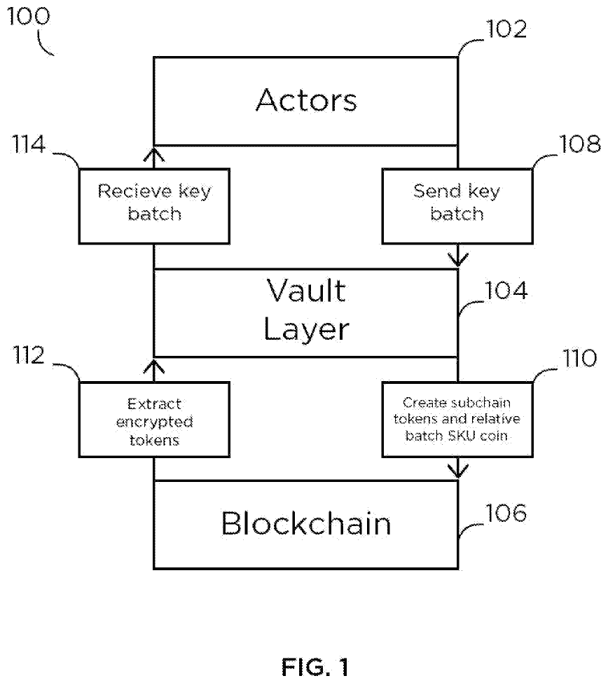

FIG. 1 is a diagram illustrating the main layers of the key batch creation and distribution system according to embodiments of the inventive subject matter;

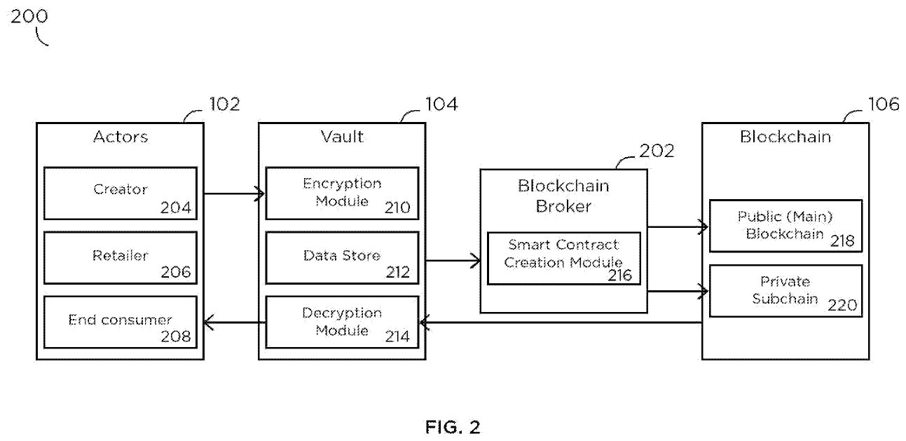

FIG. 2 is a diagram illustrating inner modules and parts of key batch creation and distribution system according to embodiments of the inventive subject matter;

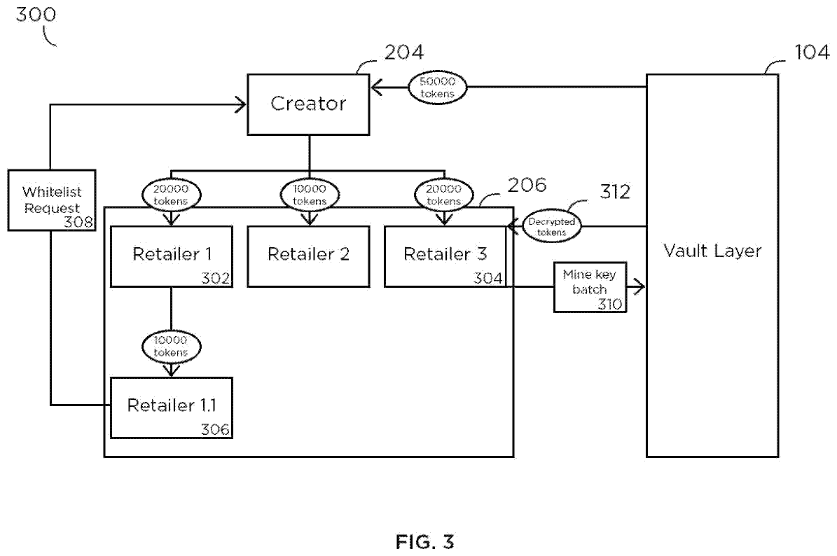

FIG. 3 is a diagram explaining key distribution between actors according to embodiments of the inventive subject matter;

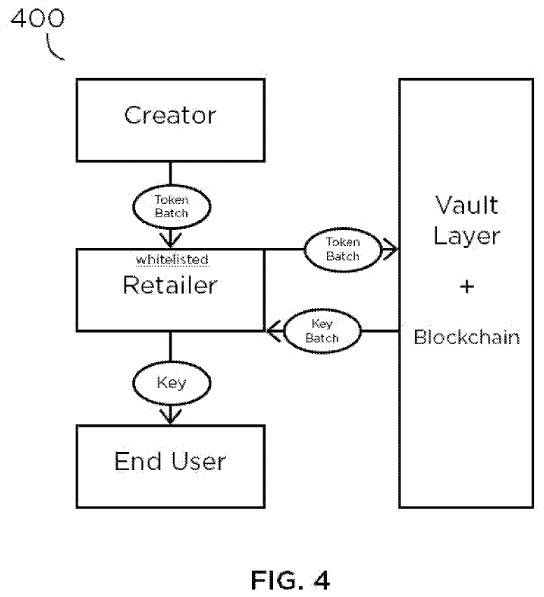

FIG. 4 is a diagram elaborating a possible scenario of key decryption and distribution according to embodiments of the inventive subject matter;

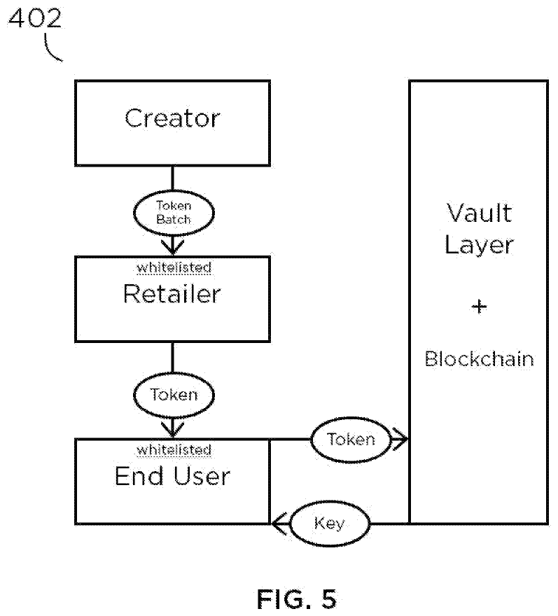

FIG. 5 is a diagram elaborating another possible scenario of key decryption and distribution according to embodiments of the inventive subject matter;

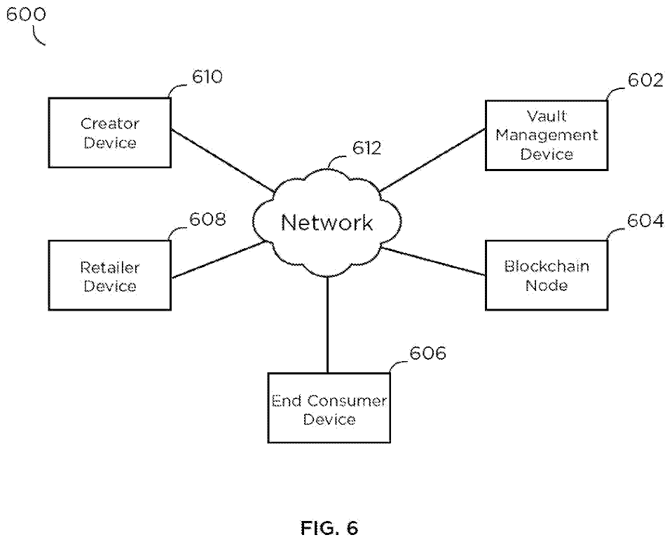

FIG. 6 is a diagram illustrating the distribution system according to embodiments of the inventive subject matter;

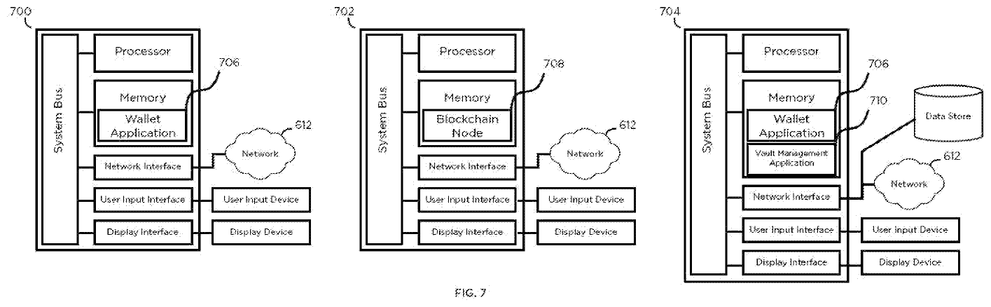

FIG. 7 is a diagram illustrating exemplary system devices for users, blockchain nodes, and vault management devices according to embodiments of the inventive subject matter; and

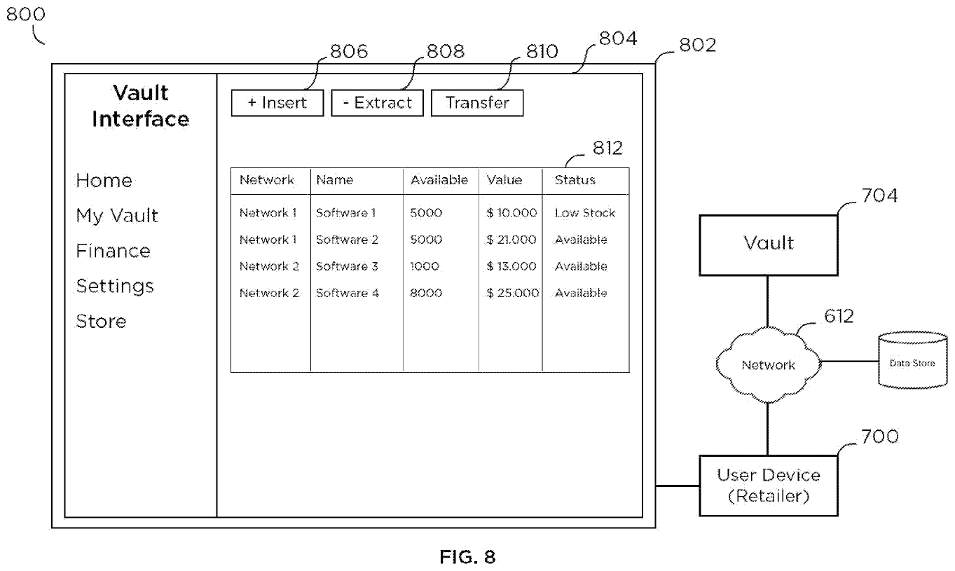

FIG. 8 is a diagram illustrating a user interface provided by an app, an applet of a website according to embodiments of the inventive subject matter.

### DETAILED DESCRIPTION OF THE EMBODIMENTS

According to embodiments of the claimed subject matter, various apparatuses, systems and methods systems for

The following part discusses this application in-depth with reference to the accompanying drawings and embodiments in order to make the objectives, technical solutions, and advantages of this application clearer and more comprehensible. It is important to note that the precise embodiments described above are provided for explanatory purposes and are not limiting.

One technical problem being solved with the present inventive subject matter is the secure and efficient distribution of software license keys using blockchain technology. Current methods of software key distribution may not be secure enough and may not provide sufficient transparency for the copyright owner, distributors, and end consumers. Many of the embodiments described in the patent aim to address these issues by using blockchain technology to create a secure and transparent system for the distribution of software license keys.

The illustrative embodiments of the inventive subject matter can be particularly beneficial to different kinds of software copyright owners such as publishers, distributors, retailers, vendors, and end consumers. Many of the embodiments aim to accelerate, reinforce the security, and increase transparency of the license key distribution.

In one embodiment, a copyright owner, for example a person or an entity, called a creator 204, sends batches of keys 108 to the vault layer 104 for the purpose of distributing owned product through a distributor 206 (or in some embodiments directly to the end consumer 208) where they are hashed and encrypted. A batch of tokens is then created, with the number of tokens in the batch equal to the encrypted keys that they represent, and an SKU coin is minted carrying token addresses through its metadata 110 in the blockchain 106. If a request is made to extract a number of keys, an equal number of tokens and encrypted keys are extracted 112, decrypted in the vault layer, and dispatched 114 to the receiving end.

In another embodiment, the vault layer 104 may act as a security layer and is responsible for the encryption of input keys to the system using encryption module 210, and decryption of the output keys using decryption module 214 which are to be delivered to the end-user or end-users binds the whole mechanism end-to-end. Every key in the batch is sent to the vault layer and assigned a hash for individual identification of keys, and, for each key in the batch, a token is allocated in the private subchain 220 and a smart contract template 216 is created by the blockchain broker 202 to mint key batch coin in the public blockchain 218. In an embodiment, a request from a creator can trigger a procedure such as: encrypted keys are extracted from the tokens, sent to the vault layer, decrypted in the decryption module, and delivered to a retailer to be distributed. In another embodiment, utilizing a distribution sub-system, decrypted keys may be deployed directly to the end consumer using an interface.

In another embodiment, a certain part of the distribution of a key batch comprises the delivery of allocated tokens to the creator 204 and the distribution of tokens to the whitelisted retailers 206. In some embodiments, a retailer 302 may want to relocate a part of the owned tokens to another retailer 306. The batch creator has the authority to add more to the whitelist. In several embodiments, a process is used to input a key batch containing 50000 keys and 50000 tokens are allocated to the creator wallet. The creator directly distributes it as; 20000 tokens to Retailer 1, 10000 tokens to Retailer 2, and 20000 tokens to Retailer 3. As shown in the figures, “Retailer 1” 302 splits up the owned tokens and decides to send them to “Retailer 1.1” 306. To proceed to the transaction, the Retailer 1.1 wallet has requested to be whitelisted 308. Creator whitelists the wallets that they are directly interacting with and receives whitelist requests for indirect distribution of tokens.

In an embodiment illustrated by FIG. 4, extracted token batches which are sent to the retailer wallet may be decrypted and identified in the vault and a key batch is returned to the retailer with keys to be distributed to the end consumers via one or more purchase transactions. In another embodiment illustrated by FIG. 5, extracted token batches that are sent to the retailer wallet may be sent to the end consumer wallets via purchase to be decrypted and identified in the vault and the purchased key is returned to the end consumer. In many of these embodiments, the end user's consumer wallets involve whitelisting or pre-clearing the wallets before they receive a purchase key is sent to the wallets.

Conceptual layers and modules according to several of the embodiments are illustrated in FIG. 6. In an embodiment 600, wherein the components of the system are connected through a network, key batches are sent to the vault layer by the creator using a computing device. Keys are hashed and encrypted in the modules in the Vault management device 602. Tokens and key batch coins, minted in a blockchain, run in one or more blockchain nodes 604 and can be distributed to the retailers 608. With an extraction request sent to the vault management device, keys are extracted from the tokens and then distributed to the end consumers 606 directly as keys. In another embodiment, tokens may also be allocated to the end consumers after the individual sale of a key (represented by a token) and they may send an extraction request to the vault leading to the receipt of a decrypted software key.

An exemplary system comprising the vault management device 704 that is responsible for vault layer modules comprises a device with at least one processor, an input interface coupled with one or more input devices, a display interface coupled with a display device, a network interface connected to the network, a memory coupled with the processor that are storing instructions that when executed, and a cause vault management application for implementing the steps of the inventive subject matter. In these embodiments, one or more blockchain nodes 702 that is responsible for block producing is a device with at least one processor, an input interface coupled with one or more input devices, a display interface coupled with a display device, a network interface connected to the network, and a memory coupled with the processor that store instructions for execution. When executed, the blockchain node runs the described steps.

One or more of the user devices 700 which are responsible for transactions, can be made up of a device with at least one processor, an input interface coupled with one or more input devices, a display interface coupled with a display device, a network interface connected to the network, and a memory coupled with the processor for storing instructions to be executed. When executed, the wallet application runs the described steps.

In an exemplary embodiment, a user 204, also known as a creator, uses a vault interface provided by an app, applet, or a website to deploy a key batch to the system, wherein the vault management device 602 executes instructions such as individual encryption, hashing, and storage of the keys on the data storage, and sending instructions to blockchain node 604 for allocating tokens in the private subchain 220 and for minting batch coin in public blockchain 218.

In some embodiments, the user 204 may want to transfer batch tokens to another user (such as a retailer) using the vault interface, utilizing the wallet application connected to the blockchain node 604, tokens and related coin transferred simultaneously from wallet to wallets like parallel transactions occurring in both public and private blockchain. Following this, users in the receiving end (retailer) 206, using the vault interface, may request the extraction of key batches. After receiving a request from vault management application 710, the vault management device 704 executes instructions such as parsing token batch and data store for paired hashes, identifying paired keys, decrypting paired keys, creating a key batch, and sending the batch to the user (retailer) device.

In many of the embodiments, a user (retailer), connecting the vault user interface, uses a computing device 700 which is connected to a display device 802 and a network 612. In these embodiments, the Vault management device 704 that is responsible for the vault layer running vault management application 710 receives a fetch request for that specific user and transmits related data to the user device to be displayed on display device 802 providing direct management over the owned products (which can be the products being purchased or which have been purchased.) By connecting the vault interface 804 and fetching related data to that specific user, the retailer has easy access to administrative system information that is displayed in a sub-panel 812 and which can be used for software key management including, but not limited to: owned key batches, one or more provider of one or more systems, one or more networks associated with the software, one or more names used for the software, the number of available keys, the types of keys, the total value of the keys and the overall status of the key batch.

In these embodiments, users using the vault interface 804 can utilize a wallet application 706 connected to one or more blockchain nodes through a network 604 that is integrated to the vault interface 804. After a user is authenticated and authorized by the wallet application, the user may insert token batches 806 to the system, extract one or more keys 808 from the token batches 806 and then distribute one or more tokens 810 to an end consumer or to another user such as another retailer. In some of these embodiments, one or more tokens 810 of token batches 806 may be resold from one retailer to another retailer or distributor and these tokens 810 may be part of one or more token batches 806.

In some of the embodiments, once token batches 806 have been distributed to the end users and the extracted keys have been securely stored and used for their intended purposes, the token batches 806 may no longer be needed by the retailer. In some circumstances, token batches 806 can be returned to the retailer, such as when the token batches 806 are no longer in use or when the retailer wants to update the token batches 806.

In many embodiments, the process of returning one or more token batches 806 to a retailer may involve the following steps:
Request: The end users or the one or more of the token batches 806 holders may request the return of one or more of the token batches 806 from the retailer. This request should include details about the one or more of the token batches 806, such as the batch number, the date of issuance, and any other relevant information;
Verification: The retailer may verify the authenticity of the request and confirm that the one or more of the token batches 806 holder has the authority to return the key batch. This may involve validating the identity of the one or more of the token batches 806 holder and checking the terms and conditions of the key issuance agreement;
Collection: Once the request has been verified, the retailer may arrange for the collection of the one or more of the token batches 806 from the end users or the one or more of the token batches 806 holder. This may involve coordinating with the end users to ensure that the keys are securely erased or destroyed before being returned;
Storage: After the one or more of the token batches 806 have been collected, the retailer may store the one or more of the token batches 806 securely to ensure that they are not accessible to unauthorized users. This may involve encrypting the one or more of the token batches 806 and storing them in a secure location; and
Destruction: If the one or more of the token batches 806 are no longer needed, the retailer may destroy one or more of the token batches 806 to prevent any further use. This may involve securely erasing the one or more of the token batches 806 from any storage media and physically destroying the storage media to ensure that the one or more of the token batches 806 cannot be recovered.

In many embodiments, after an extracted key batch is created and sent to the requesting end user, several steps may be involved in the key management process. Here are some possible steps that may be taken:
Storage: The extracted key batch may be stored securely by the end user, typically in an encrypted form, to ensure that it is not accessible to unauthorized users;
Key usage: The end user may use the extracted keys for their intended purpose, such as to decrypt data that was encrypted using the corresponding public keys;
Key rotation: Over time, the end user may need to rotate or update the extracted keys to ensure their ongoing security. This may involve creating a new batch of extracted keys and replacing the old ones;
Revocation: If the end user suspects that the extracted keys have been compromised or if a key has been lost or stolen, the corresponding keys may need to be revoked to prevent unauthorized access to the data or system; and
Auditing: The key management process may be audited to ensure that it complies with security policies and regulations. This may involve keeping a record of all key usage, rotations, and revocations.

In addition to these steps, other key management practices may be employed to enhance the security of the extracted key batch. For example, the key batch may be split into multiple parts and stored in different locations to prevent a single point of failure. The key batch may also be encrypted using a strong encryption algorithm and a secure key management system to ensure that it is not accessible to unauthorized users.

The features, processes, and components of the illustrated embodiments can be combined in a variety of ways and are not limited to the described processes, methods and systems. To be specific, components of the multi-layer approach that is presented in this disclosure may comprise a wide variety of choices, the actors and the technical and business relationship between the actors may wary, technical capabilities and modules in the vault layer may be wider, blockchain modules may comprise only public blockchain, only private blockchain, or one or more of both public and private blockchains. The tokenization of keys may utilize fungible or non-fungible tokens. Additionally, any third-party modules may be inserted in or used with the disclosed systems and methods. The described embodiments may be combined with a wide range of smart devices and/or communications options. Any additional changes, substitutions, and/or additions that are contemplated to be within the spirit and scope of the disclosure may be made by one skilled in the art.

What is claimed is:

1. A computer implemented system for distributing tokens corresponding to one or more keys comprising a network connected system using a vault device with one or more blockchains wherein the network connected system:
determines a hash value of and encrypt the one of more keys;
creates one or more tokens;
mints one or more coins with batched token addresses in a distributed ledger;
extracts one or more of the keys from the batched token addresses on request from a user, and
decrypts and distributes the one or more extracted keys to one or more end users.

2. The computer implemented system of claim 1 wherein the one or more extracted keys are software keys that may be used for online license activation by one or more recipients of the one or more extracted keys.

3. The computer implemented system of claim 1 wherein the keys are batches of keys and wherein the number of tokens created in the batch is equal to the encrypted keys that they represent, and an SKU coin is minted carrying token addresses associated with each token through its metadata in the one or more blockchains.

4. The computer implemented system of claim 1 wherein if a request is made to extract a number of keys, an equal number of tokens and encrypted keys are extracted, decrypted and distributed.

5. The computer implemented system of claim 1 wherein the one or more coins minted in a distributed ledger include metadata that contains the array of token addresses for each token that is created.

6. The computer implemented system of claim 5 wherein the one or more coins represent N number of transferrable assets which is equal to the number of token addresses in the coin metadata wherein when X number of keys are to be sold, X number of tokens are transferred to the receiving wallet, coins are extracted and decrypted in the vault layer and wherein when the process is completed, metadata of the coin in the public chain is updated as the extracted addresses are removed from the array, resulting in N-X number of token addresses and N-X number of tokens in the private sub-chain on the related batch.

7. The computer implemented system of claim 1 wherein the vault device encrypts the one or more keys using an encryption module and decrypts the one or more extracted keys using a decryption module.

8. The computer implemented system of claim 1 wherein the one or more keys are assigned a hash for the identification of the one or more individual keys, and, for each key in the batch, a token is allocated in a private subchain and a smart contract template is created by a blockchain broker to mint on or more key batch coins in the distributed ledger.

9. The computer implemented system of claim 1 wherein the extraction of keys by request of one or more end users is preapproved by a provider of the one or more keys so that only those one or more end users receive the one or more extracted keys.

10. The computer implemented system of claim 9 wherein the one or more end users may preapprove, before or after receipt of the extracted keys, one or more third parties to receive one of more of the extracted keys.

11. The computer implemented system of claim 9 wherein the provider of the one or more keys may receive requests from one or more third party users so that the third party users can be approved by the provider with the grant or denial of those requests resulting in the third parties users being accepted or denied inclusion into a whitelist containing the list of preapproved end users.

12. The computer implemented system of claim 9 wherein the one or more keys extracted from the token batches may be sent to a retailer wallet to be decrypted and identified in the vault device and wherein one or more token batches are returned to the retailer while one or more keys are distributed to one or more end users when the one or more end users complete one or more purchase transactions.

13. The computer implemented system of claim 12 wherein the one or more keys are distributed to one or more end users after one or more end users have been whitelisted.

14. The computer implemented system of claim 1 wherein the one or more end users transfer one or more batch tokens to one or more other receiving end users utilizing the vault device utilizing a wallet application that is in communication with the distributed ledger.

15. The computer implemented system of claim 14 wherein the one or more end users transfer one or more batch tokens and any related one or more coins to one or more other receiving end users on a public distributed ledger or a private distributed ledger or both a public distributed ledger and a private distributed ledger.

16. The computer implemented system of claim 14 wherein once the one or more other receiving end users receive the one or more batch tokens and the related one or more coins, the one or more requesting end users requests the extraction of the batch tokens and the vault device parses the batch tokens and data store for paired hashes, identifies the paired keys, decrypts the paired keys, creates a key batch, and sends the resulting batch to the requesting end user.

17. A computer implemented system of claim 1 further comprising a vault user interface including a computing device with a vault management application and a display in communication with the network connected system wherein the vault management application can receive a request from a vault user interface user and, in response, transmit related data to the user device specific to the vault user interface user which can be displayed on the display.

18. A computer implemented system of claim 17 wherein the vault interface allows the user to manage one or more products purchased using the one or more keys.

19. A computer implemented system of claim 17 wherein the vault interface can be used by the retailer to fetch related data to that specific vault user interface user so that the data can be used for key management related to the vault interface user.

20. A computer implemented system of claim 19 wherein key management related to the vault interface user includes management of one or more of the following: owned key batches, one or more provider of one or more systems, one or more networks associated with the software, one or more names used for the software, the number of available keys, the types of keys, and the total value of the keys and the overall status of the key batch.
